(19) United States
(12) Patent Application Publication
(10) Pub. No.: US 2017/0116630 A1
(43) Pub. Date: Apr. 27, 2017

(54) METHOD AND SYSTEM FOR GEOGRAPHICAL PRICE MAPPING OF PHARMACEUTICALS

(71) Applicant: MASTERCARD INTERNATIONAL INCORPORATED, Purchase, NY (US)

(72) Inventors: Arun ELANGOVAN, Astoria, NY (US); Andrey BIRUKOV, Scarsdale, NY (US); Edward LEE, Scarsdale, NY (US)

(73) Assignee: MASTERCARD INTERNATIONAL INCORPORATED, Purchase, NY (US)

(21) Appl. No.: 14/921,516

(22) Filed: Oct. 23, 2015

(51) Int. Cl. G06Q 30/02

(52) U.S. Cl. CPC G06Q 30/0206

(57) ABSTRACT

A method for analyzing geographical pricing for products using transaction data includes: storing product data entries, each including data related to a product including a product identifier and a plurality of price values, each associated with a geographic area; receiving a transaction message for a payment transaction including a geographic location and addendum data, the addendum data being configured to store a specific product identifier and associated an associated price; extracting the specific product identifier and associated price stored in the addendum data; executing a query on the product database to identify a specific product data entry that includes the extracted specific product identifier; and updating a specific price value of the plurality of price values included in the identified specific product data entry in the product database associated with a geographic area including the geographic location based on the extracted associated price.

### FIELD

The present disclosure relates to the analysis of geographical pricing for products using transaction data, specifically the generation of a price map illustrating product pricing in a plurality of geographic areas captured from transaction data for a product, particularly pharmaceutical products.

### BACKGROUND

Consumers will often purchase a particular product over other particular products, or purchase a specific product at one merchant over another, for any variety of reasons, such as quality, taste, texture, customer service, reliability, convenience. One factor that may be the most influential for a large number of consumers when it comes to selecting a merchant or product over another is the price. Some consumers have been known to go well out of their way to visit a merchant to purchase a product for even the smallest discount over the price offered for the product by a competing merchant. As a result, many consumers are often interested in tools to help them find the lowest price for a product.

Some tools that have been developed include websites and application programs that a consumer may visit that list pricing information for specific products at a plurality of different merchants. Most commonly, these tools gather pricing information one of two ways: via crowdsourcing by having visiting consumers submit pricing information, or by specific users (e.g., employees, moderators, designated contributors, etc.) or tools (e.g., web crawlers, scripting engines, etc.) that will visit webpages and view advertisements for the different merchants to identify product pricing information. However, such tools may be inaccurate, outdated, and subject to human error, especially in instances where product pricing may vary for multiple physical locations of a single merchant. Furthermore, such tools often compare merchants to one another generally, without regard for geographic locations, which may themselves provide a basis for difference in price.

Thus, there is a need for a technical solution for improved capturing of product pricing information for use in providing comparison of product pricing information in different geographic areas. By capturing product pricing information via transaction data for payment transactions being processed, data may be captured that is accurate to the actual price charged for the product, as well as the geographic location of the transaction, resulting in improved product price mapping using the methods and systems discussed herein.

### SUMMARY

The present disclosure provides a description of systems and methods for analyzing geographical pricing for products using transaction data.

A method for analyzing geographical pricing for products using transaction data includes: storing, in a product database of a processing server, a plurality of product data entries, wherein each product data entry includes data related to a product including at least a product identifier and a plurality of price values, each price value being associated with a geographic area of a plurality of geographic areas; receiving, by a receiving device of the processing server, a transaction message for a payment transaction via a payment network, wherein the transaction message is formatted based on one or more standards and includes a plurality of data elements including at least a first data element configured to store a geographic location and one or more additional data elements configured to store a specific product identifier and an associated price; extracting, by a processing device of the processing server, the specific product identifier and the associated price stored in the one or more additional data elements included in the received transaction message; executing, by the processing device of the processing server, a query on the product database to identify a specific product data entry where the included product identifier corresponds to the extracted specific product identifier; and updating, by the processing device of the processing server, a specific price value of the plurality of price values included in the identified specific product data entry in the product database based on the extracted associated price, wherein the specific price value is associated with a geographic area that includes the geographic location stored in the first data element included in the received transaction message.

Another method for analyzing geographical pricing for products using transaction data includes: storing, in a product database of a processing server, a plurality of product data entries, wherein each product data entry includes data related to a product including at least a product identifier and a plurality of price values, each price value being associated with a geographic area of a plurality of geographic areas; receiving, by a receiving device of the processing server, a transaction message for a payment transaction via a payment network, wherein the transaction message is formatted based on one or more standards and includes a plurality of data elements, including at least a first data element configured to store a geographic location, and addendum date, the addendum data configured to store at least a specific product identifier and associated an associated price; extracting, by a processing device of the processing server, the specific product identifier and the associated price stored in the addendum data included in the received transaction message; executing, by the processing device of the processing server, a query on the product database to identify a specific product data entry where the included product identifier corresponds to the extracted specific product identifier; and updating, by the processing device of the processing server, a specific price value of the plurality of price values included in the identified specific product data entry in the product database based on the extracted associated price, wherein the specific price value is associated with a geographic area that includes the geographic location stored in the first data element included in the received transaction message.

A system for analyzing geographical pricing for products using transaction data includes a product database, a receiving device, and a processing device of a processing server. The product database of the processing server is configured to store a plurality of product data entries, wherein each product data entry includes data related to a product including at least a product identifier and a plurality of price values, each price value being associated with a geographic area of a plurality of geographic areas. The receiving device of the processing server is configured to receive a transaction message for a payment transaction via a payment network, wherein the transaction message is formatted based on one or more standards and includes a plurality of data elements including at least a first data element configured to store a geographic location and one or more additional data elements configured to store a specific product identifier and an associated price. The processing device of the processing server is configured to: extract the specific product identifier and the associated price stored in the one or more additional data elements included in the received transaction message; execute a query on the product database to identify a specific product data entry where the included product identifier corresponds to the extracted specific product identifier; and update a specific price value of the plurality of price values included in the identified specific product data entry in the product database based on the extracted associated price, wherein the specific price value is associated with a geographic area that includes the geographic location stored in the first data element included in the received transaction message.

Another system for analyzing geographical pricing for products using transaction data includes a product database, a receiving device, and a processing device of a processing server. The product database of the processing server is configured to store a plurality of product data entries, wherein each product data entry includes data related to a product including at least a product identifier and a plurality of price values, each price value being associated with a geographic area of a plurality of geographic areas. The receiving device of the processing server is configured to receive a transaction message for a payment transaction via a payment network, wherein the transaction message is formatted based on one or more standards and includes a plurality of data elements, including at least a first data element configured to store a geographic location, and addendum date, the addendum data configured to store at least a specific product identifier and associated an associated price. The processing device of the processing server is configured to: extract the specific product identifier and the associated price stored in the addendum data included in the received transaction message; execute a query on the product database to identify a specific product data entry where the included product identifier corresponds to the extracted specific product identifier, and update a specific price value of the plurality of price values included in the identified specific product data entry in the product database based on the extracted associated price, wherein the specific price value is associated with a geographic area that includes the geographic location stored in the first data element included in the received transaction message.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for analyzing geographical pricing for products using transaction data in accordance with exemplary embodiments.

FIG. 2 is a block diagram illustrating the processing server of FIG. 1 for analyzing geographical pricing for products using transaction data in accordance with exemplary embodiments.

FIG. 3 is a flow diagram illustrating a process for the analysis of geographical pricing for products based on transaction data for generation of a pricing map in accordance with exemplary embodiments.

FIG. 4 is a diagram illustrating a price map generated from performing analysis of geographical price data based on transaction data in accordance with exemplary embodiments.

FIGS. 5 and 6 are flow charts illustrating exemplary methods for analyzing geographical pricing for products using transaction data in accordance with exemplary embodiments.

FIG. 7 is a flow diagram illustrating the processing of a payment transaction in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant. In some instances, as used herein, the term “merchant” may refer to an apparatus or device of a merchant entity.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Analysis of Geographical Pricing Using Transaction Data

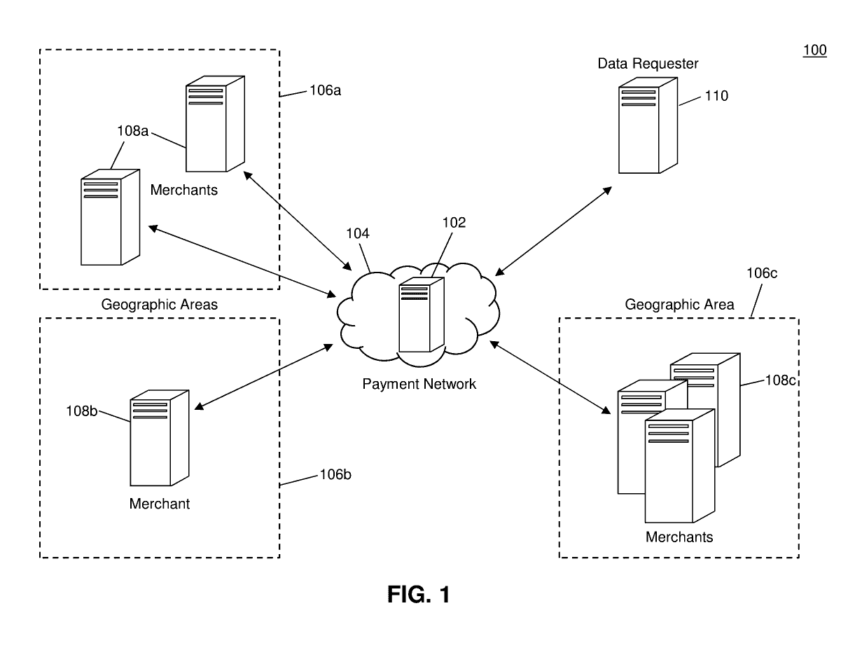

FIG. 1 illustrates a system 100 for the analysis of geographical pricing for a product using data captured from payment transactions conducted for the purchase of the product over a plurality of different geographic areas.

The system 100 may include a processing server 102. The processing server 102, discussed in more detail below, may be configured to analyze pricing of a product over a plurality of different geographical areas based on data captured from processed payment transactions. The processing server 102 may be part of a payment network 104 configured to process payment transactions, and may receive transaction data for payment transactions processed thereby for use in analyzing geographical pricing for a product over a plurality of geographic areas 106, illustrated in FIG. 1 as geographic areas 106a, 106b, and 106c.

Each of the geographic areas 106 may include one or more merchants 108, such as the merchants 108a in the geographic area 106a, the merchant 108b in the geographic area 106b, and the merchants 108c in the geographic area 106c, as illustrated in FIG. 1. The processing server 102 may be configured to analyze transaction data corresponding to payment transactions involving the merchants 108 to determine that a specific product was purchased, identify the price of the product charged in the payment transaction, and identify the geographic area 106 associated with the purchase for use in maintaining a database of pricing for the product.

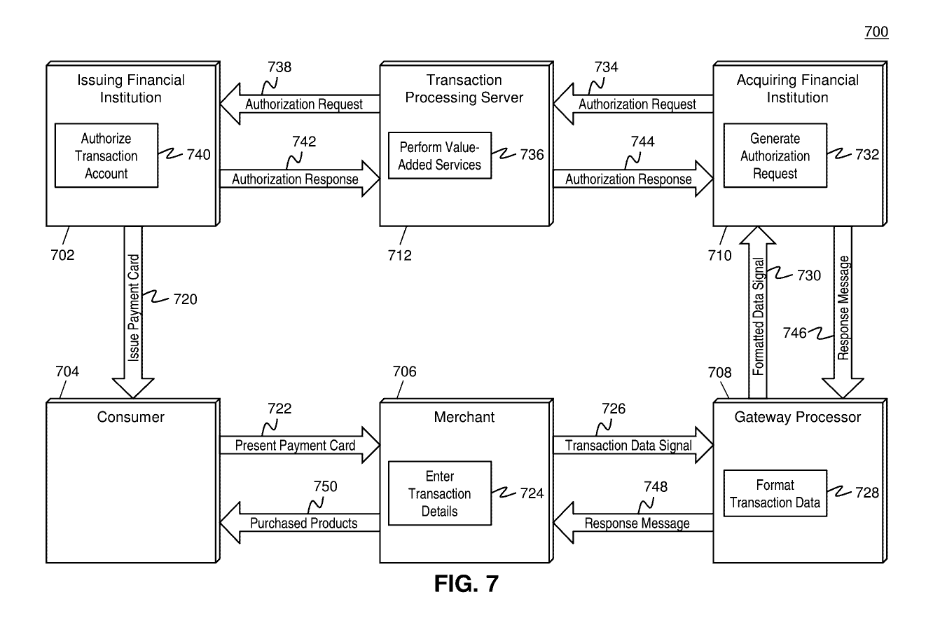

Each of the merchants 108 in the various geographic areas 106 may be configured to initiate a payment transaction for the purchase of a product by a consumer. The initiation of the payment transaction may include the use of a point of sale device or other suitable type of computing device to input or otherwise receive product details for one or more products being purchased and payment details from a consumer that are associated with a transaction account used to fund the payment transaction. The point of sale device or other computing system of the merchant 108 may transmit transaction details for the payment transaction, that include the product details and payment details, to another entity, such as a gateway process or acquiring financial institution, for forwarding on to the payment network 104 in a transaction message for processing using the payment rails. The payment rails and additional information regarding the transmission of payment details from a merchant 108 to a payment network 104 for processing is discussed in more detail below with respect to the process 700 illustrated in FIG. 7.

Once the payment transaction for the purchase of a product has been initiated at the merchant 108, the payment network 104 may receive a transaction message for the payment transaction. The transaction message may be formatted based on one or more standards governing the exchange of financial transaction messages, such as the International Organization for Standardization's ISO 8583 standard. The transaction message may include a plurality of data elements, such as set forth in the associated standard(s). For example, the transaction message may include a data element configured to store a geographic location for the related payment transaction, a data element configured to store a primary account number associated with a transaction account used to fund the payment transaction, a data element configured to store a transaction amount, a data element configured to store a transaction time, etc. The transaction message may also include a message type indicator, which may indicate a type for the transaction message. For example, transaction messages transmitting from the merchant 108 to the payment network 104 (e.g., via one or more intermediate entities) may include a message type indicator indicative of an authorization request.

In some embodiments, the transaction message may include one or more data elements configured to store product and pricing data. The product and pricing data may include a product identifier and a product price. The product identifier may be a unique value associated with a product purchased in the related payment transaction, such as a universal product code, stock-keeping unit, European article number, International Standard Book Number, registration number, serial number, or other suitable identification value. The product price may be a price charged, paid, or otherwise associated with the related product. In some instances, a transaction message may include product and pricing data for multiple products. In some cases, a single data element may store all of the product and pricing data for a payment transaction, and may be formatted in any suitable format for the storage of the associated data therein. In other cases, a separate data element may be used for the storage of product and pricing data for each product purchased in the related payment transaction. In yet other cases, each data element may be configured to store either product data or pricing data for a single product purchased in the related payment transaction.

In some embodiments, the transaction message may include an addendum, which may comprise additional data not stored in the data elements of the transaction message. In such embodiments, the product and pricing data may be stored in the addendum to the transaction message. In some instances, the data stored in the addendum may be formatted and/or included as set forth by the payment network 104, processing server 102, merchants 108, or other entity involved in the processing of payment transactions, such as issuers, acquirers, or gateway processors. In some embodiments, the processing server 102 may be configured to analyze product pricing based on product and pricing data stored in both data elements and addendums of payment transactions.

The transaction messages and/or data included therein may be provided to the processing server 102 as part of the payment network 104. In some embodiments, the processing server 102 may be external to the payment network 104. In such embodiments, the payment network 104 may electronically transmit the transaction messages to the processing server 102 via the payment rails or another suitable communication network, such as a local area network, wide area network, wireless area network, radio frequency network, the Internet, etc.

The processing server 102 may be configured to parse received transaction messages to deconstruct the transaction messages for identification of the data elements and addendum data included therein. The processing server 102 may extract the product and pricing data, as well as geographic location data, stored therein for use in analyzing geographical pricing of the associated products purchased in the payment transaction. As discussed below, the processing server 102 may maintain a database of pricing data for a particular product as associated with geographic location as identified via the data elements parsed from received transaction messages. The processing server 102 may update the price associated with the product in a geographic area 106 that includes the geographic location parsed from the transaction message, and may store associations between the geographic areas 106 and prices of the product based on the analysis for a plurality of different payment transactions.

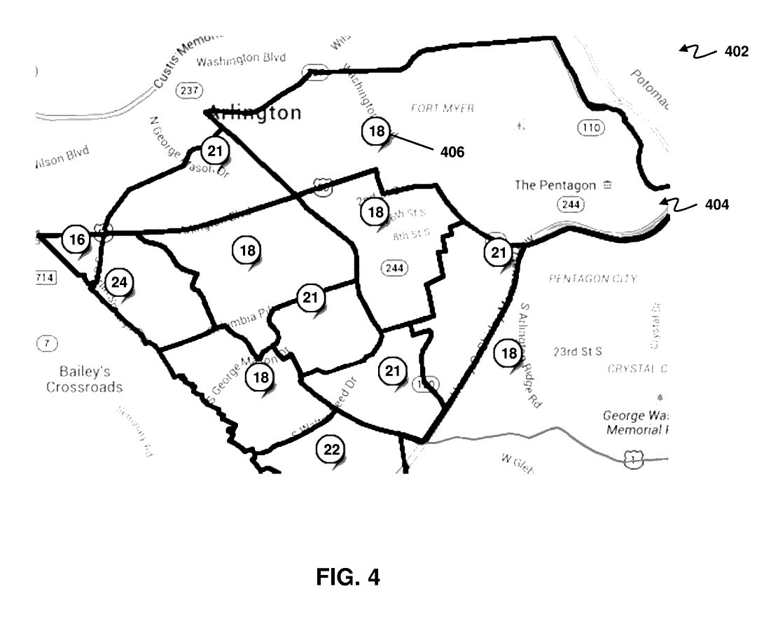

In some embodiments, the processing server 102 may be configured to generate a price map for a product based on the associations between pricing and geographic areas 106. As illustrated in FIG. 4 and discussed in more detail below, a price map may illustrate each of the geographic areas 106 for which pricing data for a product is captured and/or requested, and may include an indication of the analyzed price for the product as determined based on pricing data parsed from transaction messages that include a geographic location inside the respective geographic area.

In some instances, the system 100 may include a data requester 110. The data requester 110 may be an entity that may request data regarding the association between pricing data for a product and geographic areas 106. For example, the data requester 110 may be a merchant 108 trying to compare their prices with those of competing merchants in the same or nearby geographic areas 106, may be the product manufacturer trying to identify the prices at which their product is sold at retail, may be a research firm compiling pricing data, may be an advertising entity or other content provider that may use the data for targeting or in distributed content, may be a consumer trying to identify the best value in terms of price and location to purchase the product, may be an entity that operates a website or application program to share pricing data with consumers, etc.

The data requester 110 may electronically transmit a data signal to the processing server 102 via a suitable communication network. The data signal may be superimposed with a data request. The data request may include at least a product identifier associated with a product for which pricing data is requested. In some instances, the data request may also include a list of geographic areas 106, an overall geographic area that encompasses or otherwise consists of geographic areas 106 for which price data is requested, and/or a date range for which pricing data is requested for one or more geographic areas. The processing server 102 may parse the received data signal to obtain the data request and included data superimposed therewith. The processing server 102 may identify transaction messages associated with the purchase of the identified product using the product identifier, and may analyze the price for the geographic areas 106 indicated in the data request. In some instances, the processing server 102 may utilize previously identified pricing data, such as may be analyzed and/or updated upon the receipt of a transaction message for the purchase of the product or at a predetermined period of time, such as daily or weekly analysis of product pricing. Once the requested data is identified, the processing server 102 may electronically transmit a data signal superimposed with the requested data back to the data requester 110 via the communication network. The data requester 110 may then utilize the pricing and geographic area 106 data for the product as they desire.

The methods and systems discussed herein may enable for the processing server 102 to easily and accurately identify associations between prices for a product and geographic area. By receiving transaction messages that are transmitted to a payment network 104 via the payment rails as part of the processing of a payment transaction, the processing server 102 can ensure that the product data being captured is up-to-date and accurate, which may be significantly improved over traditional systems in that the technology is improved by requiring less human interaction, less data entry, less processing, while increasing accuracy, speed, timeliness through a more automated process using the payment rails as a source of accurate, near real time information that can be used to produce the pricing map. That is, such capture of the data may be faster than traditional methods for gathering the pricing data, and may also be at significantly less risk for human error due to the price being superimposed in a data signal that is transmitted and parsed by a specially configured technical system that is specifically built and programmed for the use thereof. As such, the systems and methods discussed herein may provide for significantly improved analysis of geographical pricing for products using data parsed from transaction messages exchanged via the payment rails using a mixture of legacy technology and new functionality and technology not previously seen.

### Processing Server

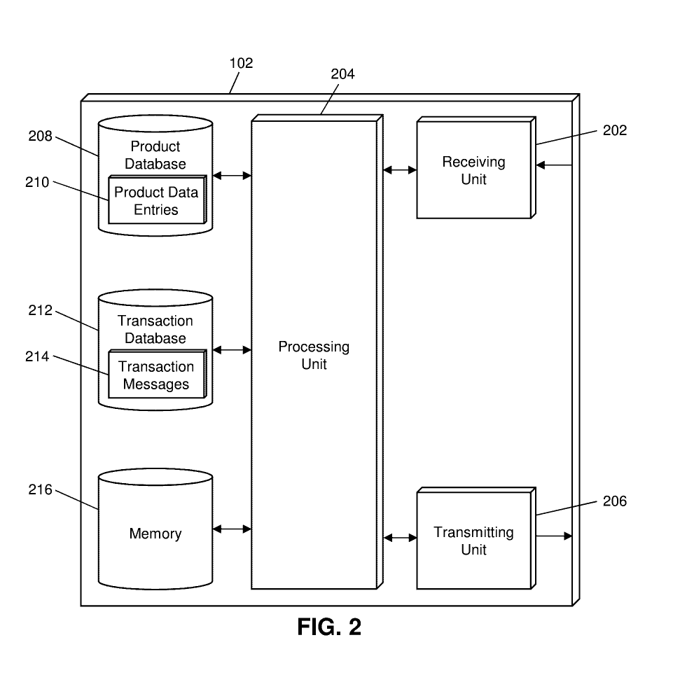

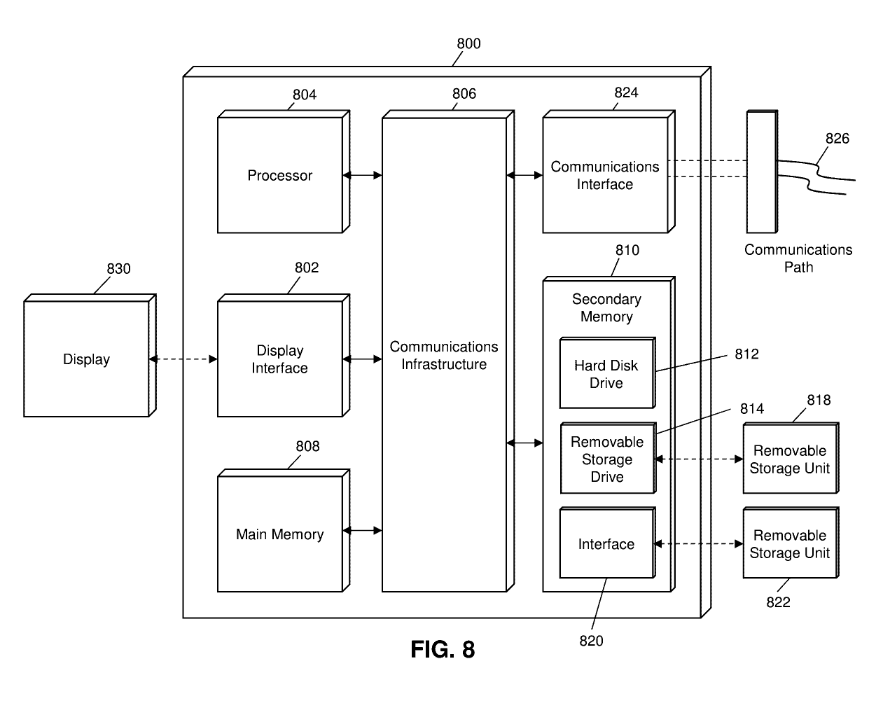

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 800 illustrated in FIG. 8 and discussed in more detail below may be a suitable configuration of the processing server 102.

The processing server 102 may include a receiving unit 202. The receiving unit 202 may be configured to receive data over one or more networks via one or more network protocols. In some embodiments, the receiving unit 202 may be configured to receive data over the payment rails, such as using specially configured infrastructure associated with payment networks 104 for the transmission of transaction messages that include sensitive financial data and information. In some instances, the receiving unit 202 may also be configured to receive data from merchants 108, data requesters 110, the payment network 104, and other entities via alternative networks, such as the Internet. In some embodiments, the receiving unit 202 may be comprised of multiple units, such as different receiving units for receiving data over different networks, such as a first receiving unit for receiving data over payment rails and a second receiving unit for receiving data over the Internet. The receiving unit 202 may receive electronically data signals that are transmitted, where data may be superimposed on the data signal and decoded, parsed, read, or otherwise obtained via receipt of the data signal by the receiving unit 202. In some instances, the receiving unit 202 may include a parsing module for parsing the received data signal to obtain the data superimposed thereon.

The receiving unit 202 may be configured to receive transaction messages from the payment network 104 (e.g., or from other entities as transmitted to the processing server 102 via the payment network 104) that include a data element configured to store a geographic location and one or more additional data elements and/or addendum data configured to store pricing and product data. The receiving unit 202 may also receive a data signal superimposed with a data request electronically transmitted from a data requester, which may, when parsed by the receiving unit 202, include a product identifier and, in some instances, one or more geographic areas 106, for which pricing data is requested.

The processing server 102 may also include a processing unit 204. The processing unit 204 may be configured to perform the functions of the processing server 102 discussed herein as will be apparent to persons having skill in the relevant art. In some embodiments, the processing unit 204 may include and/or be comprised of a plurality of engines and/or modules specially configured to perform one or more functions of the processing unit 204. For example, the processing unit 204 may include a querying module configured to query databases included in the processing server 102 to identify information stored therein. In some instances, the processing unit 204 may include a parsing module or engine configured to parse data from data signals electronically received by the receiving unit 202, an encryption module or engine configured to decrypt received data or data signals or to encrypt data or data signals received or transmitted by the processing server 102, and any other modules suitable for performing the functions discussed herein.

The processing server 102 may include a product database 208. The product database 208 may be configured to store a plurality of product data entries 210 using a suitable data storage format and schema. Each product data entry 210 may be configured to store a standardized data set (e.g., as standardized to each of the product data entries 210 stored in the product database 208) of data related to a product that includes at least a product identifier and a plurality of price values. The product identifier may be a unique value associated with the related product suitable for identification thereof. The plurality of price values may be a price for the related product and may be associated with a geographic area 106.

In some embodiments, the processing server 102 may also include a transaction database 212. The transaction database 212 may be configured to store a plurality of transaction messages 214 using a suitable data storage format and schema. The transaction messages 214 may be transaction messages received by the receiving unit 202 from and/or via the payment network 104 corresponding to payment transactions that may be used by the processing server 102 in the analysis of prices for products as associated with geographic areas. In such embodiments, transaction messages received by the receiving unit 202 may be stored in the transaction database 212 for future use in identifying prices for products. In other embodiments, transaction messages may be used when received by the receiving unit 202 and not retained. In such embodiments, the transaction database 212 may be used for temporary storage of transaction messages 214.

The processing unit 204 may include a querying module. The querying module may be configured to execute queries on databases of the processing server 102 for the identification of data stored therein. The querying module may receive a query string or parameters as input, may execute a query on an indicated database, and may output data identified via the execution of the query on the database. For example, when a transaction message is received, the querying module may execute a query on the product database 208 to identify a product data entry 210 that includes a product identifier extracted from a data element and/or addendum included in the transaction message, and may output the identified product data entry 210. In another example, the querying module may execute a query on the transaction database 212 to identify a plurality of transaction messages that include a product identifier stored in a data element and/or addendum that corresponds to a product identifier parsed from a data request received by the receiving unit 202, such as for use in identifying product price and geographic associations for the identified product.

Product identifiers may be extracted from transaction messages vi an data extraction module of the processing unit 204. The data extraction module may receive a transaction message as input and may identify and extract a product identifier from the transaction message, which may be produced as the output of the data extraction module. Product identifiers may be extracted from one or more corresponding data elements included in the transaction message, or from an addendum included in the transaction message. The data extraction module may also be configured to extract prices associated with product identifiers from transaction messages using similar processes.

The processing unit 204 may also include a price calculation module. The price calculation module may be configured to calculate a product price for a product in a geographic area 106 based on prices extracted from transaction messages that include a data element configured to store a geographic location that is included in the geographic area 106. The price calculation module may receive one or more extracted prices for a product associated with a specific geographic area 106 and may calculate and output the calculated price. The price calculated for the geographic area 106 may be an average, median, or other value indicative of a purchase price for the product in the geographic area 106 based on the prices extracted from transaction messages with geographic locations in the geographic area 106 using any suitable algorithm.

The processing unit 204 may also include a map generation module. The map generation module may be configured to generate a price map for a product. The price map may be an image or other data representation that illustrates a plurality of geographic areas 106 and indicates a price for a specific product associated with each illustrated geographic area 106, such as may be stored in the product data entry 210 related to the product and calculated by the price calculation module. In some instances, the geographic areas 106 illustrated may be all geographic areas 106 associated with a product (e.g., and stored in the corresponding product data entry 210) or may be a specific list of one or more geographic areas 106 input into the map generation module, such as may be included in and parsed from a data request submitted by a data requester 110.

The processing server 102 may further include a transmitting unit 206. The transmitting unit 206 may be configured to transmit data over one or more networks via one or more network protocols. In some embodiments, the transmitting unit 206 may be configured to transmit data over the payment rails, such as using specially configured infrastructure associated with payment networks 104 for the transmission of transaction messages that include sensitive financial data and information, such as identified payment credentials. In some instances, the transmitting unit 206 may be configured to transmit data to data requesters 110, payment networks 104, merchants 108, and other entities via alternative networks, such as the Internet. In some embodiments, the transmitting unit 206 may be comprised of multiple units, such as different transmitting units for transmitting data over different networks, such as a first transmitting unit for transmitting data over the payment rails and a second transmitting unit for transmitting data over the Internet. The transmitting unit 206 may electronically transmit data signals that have data superimposed that may be parsed by a receiving computing device. In some instances, the transmitting unit 206 may include one or more modules for superimposing, encoding, or otherwise formatting data into data signals suitable for transmission.

The transmitting unit 206 may be configured to electronically transmit a data signal superimposed with pricing data via a suitable communication network, such as to the data requester 110 in response to a received data request. The pricing data may be associations between prices for a specified product and geographic areas 106, a price for a product that is associated with a specified geographic area 106, a price map illustrating prices for the specific product in a plurality of geographic areas, or other data that may be indicated in the received data request. In some embodiments, the transmitting unit 206 may also be configured to electronically transmit a data signal superimposed with a data request to the payment network 104, such as via the payment rails or an alternative communication network, that may comprise a request for payment transaction, including a request that specified one or more product identifiers and/or geographic locations for which transaction messages are requested.

The processing server 102 may also include a memory 216. The memory 216 may be configured to store data for use by the processing server 102 in performing the functions discussed herein. The memory 216 may be configured to store data using suitable data formatting methods and schema and may be any suitable type of memory, such as read-only memory, random access memory, etc. The memory 216 may include, for example, encryption keys and algorithms, communication protocols and standards, data formatting standards and protocols, program code for modules and application programs of the processing unit 204, and other data that may be suitable for use by the processing server 102 in the performance of the functions disclosed herein as will be apparent to persons having skill in the relevant art.

### Process for Generating a Price Map Based on Transaction Data

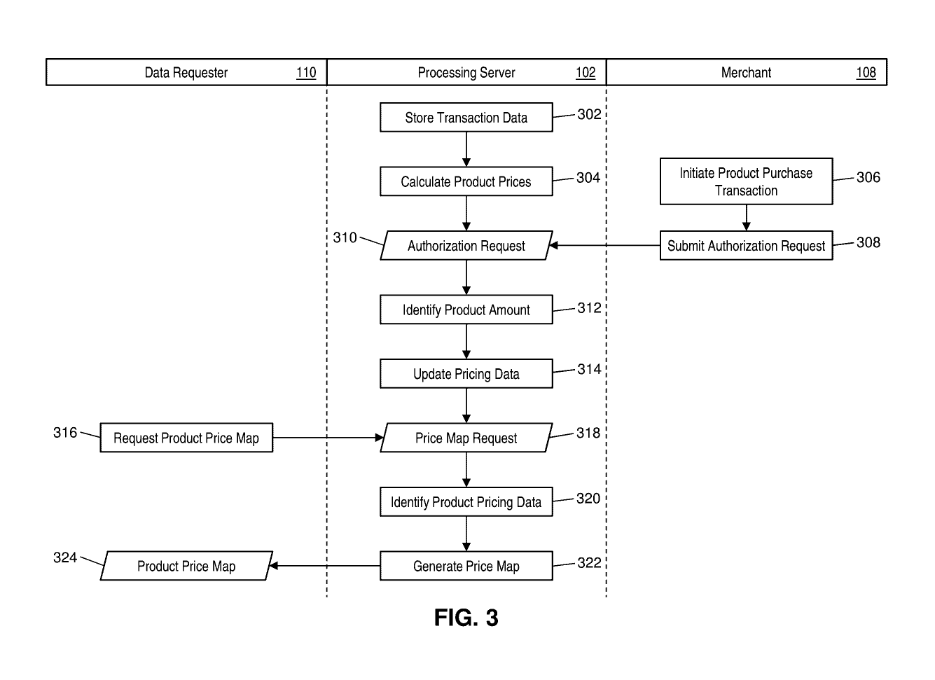

FIG. 3 illustrates a process 300 for the generation of a price map illustrating product pricing in a plurality of geographic areas as captured from transaction data for payment transactions involving the purchase of the product in the geographic areas.

In step 302, the processing server 102 may store transaction data for past payment transactions involving the purchase of the product. For instance, the processing server 102 may store a plurality of transaction messages 214 in the transaction database 212 included therein. Each transaction message 214 may be formatted based on one or more standards, such as the ISO 8583 standard, and include a data element configured to store a geographic location, and one or more additional data elements and/or an addendum configured to store a product identifier associated with the product and an associated price. In step 304, the price calculation module of the processing unit 204 of the processing server 102 may calculate a price for the product in a plurality of geographic areas 106, where the price associated with each geographic area 106 is based on a price extracted from the additional data element and/or addendum included in each transaction message 214 that includes a geographic location stored in the corresponding data element that is included in the respective geographic area 106.

In step 306, a merchant 108 may initiate a payment transaction for the purchase of the product. Initiation of the payment transaction may include the receipt and/or identification of transaction details for the payment transaction that include product data, including the product identifier for the product and an associated price, and purchase details. In step 308, an authorization request for the payment transaction may be submitted to the payment network 104 and electronically transmitted to the processing server 102 from the merchant 108 and/or one or more intermediate entities, such as an acquiring financial institution and a gateway process. The authorization request may be a transaction message that includes a message type indicator indicative of an authorization request, and may include a data element configured to store a geographic location of the merchant 108 and one or more additional data elements and/or an addendum that includes the product identifier and associated price.

In step 310, the receiving unit 202 of the processing server 102 may receive the authorization request via the payment network 104. In some instances, the receiving unit 202 and/or processing unit 204 may include a parsing module configured to parse (e.g., deconstruct) the transaction message to obtain the data stored therein. In step 312, the data extraction module of the processing unit 204 may extract the product identifier and associated price from the received authorization request, via extraction from the one or more additional data elements and/or addendum data included therein. In some instances, a further data element may be configured to store a value that may indicate where (e.g., the additional data elements or addendum) the product and pricing data is stored.

In step 314, the price calculation module of the processing unit 204 of the processing server 102 may update the pricing data for the product. The querying module may execute a query to identify the product data entry 210 stored in the product database 208 that is related to the product (e.g., includes the product identifier). The price calculation module may then update the price calculated for the geographic area 106 that includes the geographic location stored in the corresponding data element of the received transaction message based on the extracted price.

In step 316, the data requester 110 may electronically transmit a data signal to the processing server 102 via a suitable communication network that is superimposed with a product price map request. The receiving unit 202 of the processing server 102 may receive the product price map request, in step 318. The product price map request may include at least the product identifier for the product, and may, in some embodiments, also include one or more geographic areas 106 or an indication thereof for geographic areas 106 that the requested price map is to illustrate. The geographic areas may be designated by the zip code of the point of sale (POS) terminal, which is generally known and at least the POS terminal location is generally transmitted with the transaction authorization request. But other ways to generate a price map are contemplates, such as a user drawing a line on a virtual map, and all merchants that sell a particular product, as identified by address or geographic (latitude and longitude) within the map are included. However the geographic map is derived, merchants within a specified area, and by their transactions, can be identified. In step 320, the querying module of the processing unit 204 may execute a query on the product database 208 to identify the product data entry 210 that includes the product identifier (e.g., as parsed from the product price map request), and the map generation module may identify the prices included therein associated with geographic areas 106 indicated in the product price map request.

In step 322, the map generation module may generate the price map. The price map may illustrate each of the geographic areas 106 indicated in the product price map request and may indicate, for each geographic area 106, the associated price of the product. In step 324 the generated product price map may be electronically transmitted by the transmitting device 206 of the processing server 102 to the data requester 110 via a suitable communication network, and received at the data requester 110 for print-out or display on a monitor.

### Product Price Map

FIG. 4 illustrates a product price map as generated by the map generation module of the processing unit 204 of the processing server 102 in an exemplary embodiment. It will be apparent to persons having skill in the relevant art that the price map illustrated in FIG. 4 is provided as an illustration only, and that alternative representations of the price of a product as associated with geographic areas 106 identified using the methods discussed herein may be used in conjunction with the methods and systems discussed herein.

As illustrated in FIG. 4, the map generation module of the processing unit 204 of the processing server 102 may generate a price map 402. The price map 402 may illustrate a plurality of geographic areas 404. Each illustrated geographic area 404 may correspond to a geographic area 106 where a specific product that is illustrated in the price map 402 may be purchased. The price map 402 may also illustrate a product price 406 associated with each illustrated geographic area 404. For example, as illustrated in FIG. 4, each of the illustrated geographic areas 404 may be associated with a price between 16 and 24 for the product.

The price map 402 may be beneficial for a variety of different entities that may be interested in identifying associations between the price of a product and geographic area. For example, pharmaceutical products may often be available for different prices in different geographic areas, particularly for geographic areas in different countries or other municipal organizational units, such as due to taxes, regulations, etc. A price map 402 that illustrates the product price 406 for the pharmaceutical product in various illustrate geographic areas 404 (zip code or nearly any other geographic delimiter) may enable an individual looking to purchase the product to travel to a geographic area 106 where they can purchase the product for the lowest available price. In addition, because the processing server 102 uses data that is captured in transaction messages for payment transactions for the actual purchase of the product, the individual may have a higher trust of the data conveyed in the price map 402 than provided using additional methods. Here, at least relative prices (or actual prices) are designated by “18” and “21”.

### First Exemplary Method for Analyzing Graphical Pricing for Products Using Transaction Data

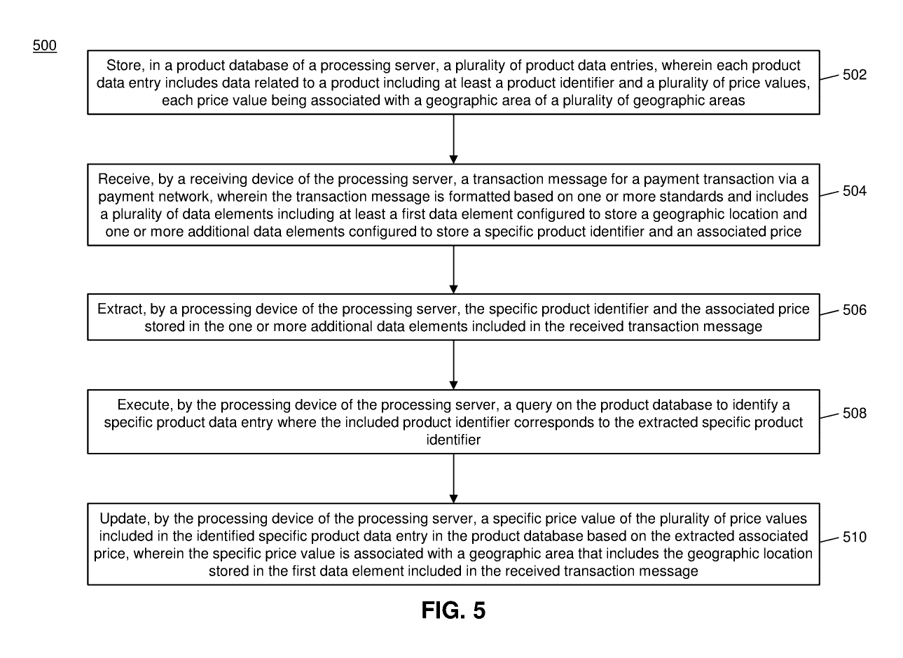

FIG. 5 illustrates a method 500 for the analysis of graphical pricing for products using transaction data based on product and pricing data stored in data elements of a transaction message.

In step 502, a plurality of product data entries (e.g., product data entries 210) may be stored in a product database (e.g., product database 208) of a processing server (e.g., processing server 102), wherein each product data entry includes data related to a product including at least a product identifier and a plurality of price values, each price value being associated with a geographic area (e.g., geographic area 106) of a plurality of geographic areas. In step 504, a transaction message for a payment transaction may be received by a receiving device (e.g., the receiving unit 202) via a payment network (e.g., payment network 104), wherein the transaction message is formatted based on one or more standards and includes a plurality of data elements including at least a first data element configured to store a geographic location and one or more additional data elements configured to store a specific product identifier and an associated price.

In step 506, the specific product identifier and the associated price stored in the one or more additional data elements included in the received transaction message may be extracted by a processing device (e.g., the processing unit 204) of the processing server. In step 508, a query may be executed by the processing device of the processing server on the product database to identify a specific product data entry where the included product identifier corresponds to the extracted specific product identifier.

In step 510, a specific price value of the plurality of private values included in the identified specific product data entry in the product database may be updated by the processing device of the processing server based on the extracted associated price, wherein the specific price value is associated with a geographic area that includes the geographic location stored in the first data element included in the received transaction message. In one embodiment, the method 500 may further include generating, by the processing device of the processing server, a price map, wherein the price map illustrates each of the plurality of geographic areas and indicates the associated price value including the updated specific price value for the specific product data entry.

In some embodiments, the method 500 may also include receiving, by the receiving device of the processing server, an electronic signal comprising a data request, wherein the data request includes the specific product identifier. In a further embodiment, the method 500 may even further include electronically transmitting, by a transmitting device (e.g., the transmitting unit 206) of the processing server, a response signal to the received electronic signal, wherein the response signal comprises one or more price values and associated geographic areas included in the specific product data entry. In an even further embodiment, the method 500 may also include: generating, by the processing device of the processing server, a price map, wherein the price map illustrates each of the plurality of geographic areas and indicates the associated price value including the updated specific price value for the specific product data entry; and electronically transmitting, by a transmitting device of the processing server, a response signal to the received electronic signal, wherein the response signal comprises the generated price map.

### Second Exemplary Method for Analyzing Graphical Pricing for Products Using Transaction Data

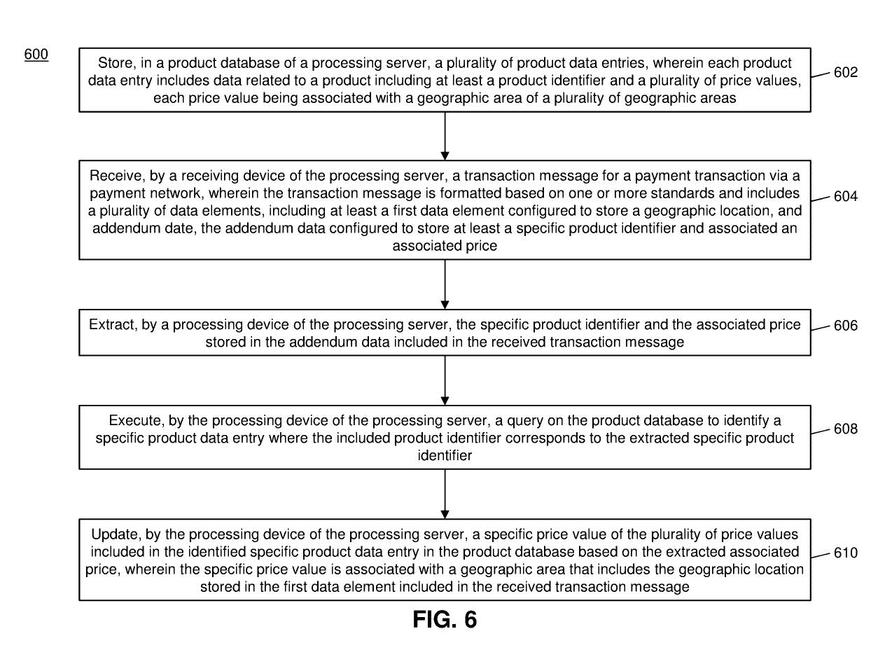

FIG. 6 illustrates a method 600 for the analysis of graphical pricing for products using transaction data based on product and pricing data stored in an addendum of a transaction message.

In step 602, a plurality of product data entries (e.g., product data entries 210) may be stored in a product database (e.g., product database 208) of a processing server (e.g., processing server 102), wherein each product data entry includes data related to a product including at least a product identifier and a plurality of price values, each price value being associated with a geographic area (e.g., geographic area 106) of a plurality of geographic areas. In step 604, a transaction message for a payment transaction may be received by a receiving device (e.g., the receiving unit 202) via a payment network (e.g., payment network 104), wherein the transaction message is formatted based on one or more standards and includes a plurality of data elements, including at least a first data element configured to store a geographic location, and addendum date, the addendum data configured to store at least a specific product identifier and associated an associated price.

In step 606, the specific product identifier and the associated price stored in the addendum data included in the received transaction message may be extracted by a processing device (e.g., the processing unit 204) of the processing server. In step 608, a query may be executed by the processing device of the processing server on the product database to identify a specific product data entry where the included product identifier corresponds to the extracted specific product identifier.

In step 610, a specific price value of the plurality of private values included in the identified specific product data entry in the product database may be updated by the processing device of the processing server based on the extracted associated price, wherein the specific price value is associated with a geographic area that includes the geographic location stored in the first data element included in the received transaction message. In one embodiment, the method 600 may further include generating, by the processing device of the processing server, a price map, wherein the price map illustrates each of the plurality of geographic areas and indicates the associated price value including the updated specific price value for the specific product data entry.

In some embodiments, the method 600 may also include receiving, by the receiving device of the processing server, an electronic signal comprising a data request, wherein the data request includes the specific product identifier. In a further embodiment, the method 600 may even further include electronically transmitting, by a transmitting device (e.g., the transmitting unit 206) of the processing server, a response signal to the received electronic signal, wherein the response signal comprises one or more price values and associated geographic areas included in the specific product data entry. In an even further embodiment, the method 600 may also include: generating, by the processing device of the processing server, a price map, wherein the price map illustrates each of the plurality of geographic areas and indicates the associated price value including the updated specific price value for the specific product data entry; and electronically transmitting, by a transmitting device of the processing server, a response signal to the received electronic signal, wherein the response signal comprises the generated price map.

### Payment Transaction Processing System and Process

FIG. 7 illustrates a transaction processing system and a process 700 for the processing of payment transactions in the system. The process 700 and steps included therein may be performed by one or more components of the system 100 discussed above, such as the merchants 108, processing server 102, and payment network 104. The processing of payment transactions using the system and process 700 illustrated in FIG. 7 and discussed below may utilize the payment rails, which may be comprised of the computing devices and infrastructure utilized to perform the steps of the process 700 as specially configured and programmed by the entities discussed below, including the transaction processing server 712, which may be associated with one or more payment networks configured to processing payment transactions. It will be apparent to persons having skill in the relevant art that the process 700 may be incorporated into the processes illustrated in FIGS. 3, 5, and 6, discussed above, with respect to the step or steps involved in the processing of a payment transaction. In addition, the entities discussed herein for performing the process 700 may include one or more computing devices or systems configured to perform the functions discussed below. For instance, the merchant 704 may be comprised of one or more point of sale devices, a local communication network, a computing server, and other devices configured to perform the functions discussed below.

In step 720, an issuing financial institution 702 may issue a payment card or other suitable payment instrument to a consumer 704. The issuing financial institution may be a financial institution, such as a bank, or other suitable type of entity that administers and manages payment accounts and/or payment instruments for use with payment accounts that can be used to fund payment transactions. The consumer 704 may have a transaction account with the issuing financial institution 702 for which the issued payment card is associated, such that, when used in a payment transaction, the payment transaction is funded by the associated transaction account. In some embodiments, the payment card may be issued to the consumer 704 physically. In other embodiments, the payment card may be a virtual payment card or otherwise provisioned to the consumer 704 in an electronic format.

In step 722, the consumer 704 may present the issued payment card to a merchant 706 for use in funding a payment transaction. The merchant 706 may be a business, another consumer, or any entity that may engage in a payment transaction with the consumer 704. The payment card may be presented by the consumer 704 via providing the physical card to the merchant 706, electronically transmitting (e.g., via near field communication, wireless transmission, or other suitable electronic transmission type and protocol) payment details for the payment card, or initiating transmission of payment details to the merchant 706 via a third party. The merchant 706 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 724, the merchant 706 may enter transaction details into a point of sale computing system. The transaction details may include the payment details provided by the consumer 704 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 706 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 706 may be an online retailer in an e-commerce transaction. In such embodiments, the transaction details may be entered in a shopping cart or other repository for storing transaction data in an electronic transaction as will be apparent to persons having skill in the relevant art.

In step 726, the merchant 706 may electronically transmit a data signal superimposed with transaction data to a gateway processor 708. The gateway processor 708 may be an entity configured to receive transaction details from a merchant 706 for formatting and transmission to an acquiring financial institution 710. In some instances, a gateway processor 708 may be associated with a plurality of merchants 706 and a plurality of acquiring financial institutions 710. In such instances, the gateway processor 708 may receive transaction details for a plurality of different transactions involving various merchants, which may be forwarded on to appropriate acquiring financial institutions 710. By having relationships with multiple acquiring financial institutions 710 and having the requisite infrastructure to communicate with financial institutions using the payment rails, such as using application programming interfaces associated with the gateway processor 508 or financial institutions used for the submission, receipt, and retrieval of data, a gateway processor 708 may act as an intermediary for a merchant 706 to be able to conduct payment transactions via a single communication channel and format with the gateway processor 708, without having to maintain relationships with multiple acquiring financial institutions 710 and payment processors and the hardware associated thereto. Acquiring financial institutions 710 may be financial institutions, such as banks, or other entities that administers and manages payment accounts and/or payment instruments for use with payment accounts. In some instances, acquiring financial institutions 710 may manage transaction accounts for merchants 706. In some cases, a single financial institution may operate as both an issuing financial institution 702 and an acquiring financial institution 710.

The data signal transmitted from the merchant 706 to the gateway processor 708 may be superimposed with the transaction details for the payment transaction, which may be formatted based on one or more standards. In some embodiments, the standards may be set forth by the gateway processor 708, which may use a unique, proprietary format for the transmission of transaction data to/from the gateway processor 708. In other embodiments, a public standard may be used, such as the International Organization for Standardization's ISO 8783 standard. The standard may indicate the types of data that may be included, the formatting of the data, how the data is to be stored and transmitted, and other criteria for the transmission of the transaction data to the gateway processor 708.

In step 728, the gateway processor 708 may parse the transaction data signal to obtain the transaction data superimposed thereon and may format the transaction data as necessary. The formatting of the transaction data may be performed by the gateway processor 708 based on the proprietary standards of the gateway processor 708 or an acquiring financial institution 710 associated with the payment transaction. The proprietary standards may specify the type of data included in the transaction data and the format for storage and transmission of the data. The acquiring financial institution 710 may be identified by the gateway processor 708 using the transaction data, such as by parsing the transaction data (e.g., deconstructing into data elements) to obtain an account identifier included therein associated with the acquiring financial institution 710. In some instances, the gateway processor 708 may then format the transaction data based on the identified acquiring financial institution 710, such as to comply with standards of formatting specified by the acquiring financial institution 710. In some embodiments, the identified acquiring financial institution 710 may be associated with the merchant 706 involved in the payment transaction, and, in some cases, may manage a transaction account associated with the merchant 706.

In step 730, the gateway processor 708 may electronically transmit a data signal superimposed with the formatted transaction data to the identified acquiring financial institution 710. The acquiring financial institution 710 may receive the data signal and parse the signal to obtain the formatted transaction data superimposed thereon. In step 732, the acquiring financial institution may generate an authorization request for the payment transaction based on the formatted transaction data. The authorization request may be a specially formatted transaction message that is formatted pursuant to one or more standards, such as the ISO 8783 standard and standards set forth by a payment processor used to process the payment transaction, such as a payment network. The authorization request may be a transaction message that includes a message type indicator indicative of an authorization request, which may indicate that the merchant 706 involved in the payment transaction is requesting payment or a promise of payment from the issuing financial institution 702 for the transaction. The authorization request may include a plurality of data elements, each data element being configured to store data as set forth in the associated standards, such as for storing an account number, application cryptogram, transaction amount, issuing financial institution 702 information, etc.

In step 734, the acquiring financial institution 710 may electronically transmit the authorization request to a transaction processing server 712 for processing. The transaction processing server 712 may be comprised of one or more computing devices as part of a payment network configured to process payment transactions. In some embodiments, the authorization request may be transmitted by a transaction processor at the acquiring financial institution 710 or other entity associated with the acquiring financial institution. The transaction processor may be one or more computing devices that include a plurality of communication channels for communication with the transaction processing server 712 for the transmission of transaction messages and other data to and from the transaction processing server 712. In some embodiments, the payment network associated with the transaction processing server 712 may own or operate each transaction processor such that the payment network may maintain control over the communication of transaction messages to and from the transaction processing server 712 for network and informational security.

In step 736, the transaction processing server 712 may perform value-added services for the payment transaction. Value-added services may be services specified by the issuing financial institution 702 that may provide additional value to the issuing financial institution 702 or the consumer 704 in the processing of payment transactions. Value-added services may include, for example, fraud scoring, transaction or account controls, account number mapping, offer redemption, loyalty processing, etc. For instance, when the transaction processing server 712 receives the transaction, a fraud score for the transaction may be calculated based on the data included therein and one or more fraud scoring algorithms and/or engines. In some instances, the transaction processing server 712 may first identify the issuing financial institution 702 associated with the transaction, and then identify any services indicated by the issuing financial institution 702 to be performed. The issuing financial institution 702 may be identified, for example, by data included in a specific data element included in the authorization request, such as an issuer identification number. In another example, the issuing financial institution 702 may be identified by the primary account number stored in the authorization request, such as by using a portion of the primary account number (e.g., a bank identification number) for identification.

In step 738, the transaction processing server 712 may electronically transmit the authorization request to the issuing financial institution 702. In some instances, the authorization request may be modified, or additional data included in or transmitted accompanying the authorization request as a result of the performance of value-added services by the transaction processing server 712. In some embodiments, the authorization request may be transmitted to a transaction processor (e.g., owned or operated by the transaction processing server 712) situated at the issuing financial institution 702 or an entity associated thereof, which may forward the authorization request to the issuing financial institution 702.

In step 740, the issuing financial institution 702 may authorize the transaction account for payment of the payment transaction. The authorization may be based on an available credit amount for the transaction account and the transaction amount for the payment transaction, fraud scores provided by the transaction processing server 712, and other considerations that will be apparent to persons having skill in the relevant art. The issuing financial institution 702 may modify the authorization request to include a response code indicating approval (e.g., or denial if the transaction is to be denied) of the payment transaction. The issuing financial institution 702 may also modify a message type indicator for the transaction message to indicate that the transaction message is changed to be an authorization response. In step 742, the issuing financial institution 740 may transmit (e.g., via a transaction processor) the authorization response to the transaction processing server 712.

In step 744, the transaction processing server 712 may forward the authorization response to the acquiring financial institution 710 (e.g., via a transaction processor). In step 746, the acquiring financial institution may generate a response message indicating approval or denial of the payment transaction as indicated in the response code of the authorization response, and may transmit the response message to the gateway processor 708 using the standards and protocols set forth by the gateway processor 708. In step 748, the gateway processor 708 may forward the response message to the merchant 706 using the appropriate standards and protocols. In step 770, the merchant 706 may then provide the products purchased by the consumer 704 as part of the payment transaction to the consumer 704.

In some embodiments, once the process 700 has completed, payment from the issuing financial institution 702 to the acquiring financial institution 710 may be performed. In some instances, the payment may be made immediately or within one business day. In other instances, the payment may be made after a period of time, and in response to the submission of a clearing request from the acquiring financial institution 710 to the issuing financial institution 702 via the transaction processing server 702. In such instances, clearing requests for multiple payment transactions may be aggregated into a single clearing request, which may be used by the transaction processing server 712 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 740), the transaction processing server 712 may be configured to perform authorization of transactions on behalf of the issuing financial institution. Such actions may be referred to as “stand-in processing,” where the transaction processing server “stands in” as the issuing financial institution 702. In such instances, the transaction processing server 712 may utilize rules set forth by the issuing financial institution 702 to determine approval or denial of the payment transaction, and may modify the transaction message accordingly prior to forwarding to the acquiring financial institution 710 in step 744. The transaction processing server 712 may retain data associated with transactions for which the transaction processing server 712 stands in, and may transmit the retained data to the issuing financial institution 702 once communication is reestablished. The issuing financial institution 702 may then process transaction accounts accordingly to accommodate for the time of lost communication.

In another example, if the transaction processing server 712 is unavailable for submission of the authorization request by the acquiring financial institution 710, then the transaction processor at the acquiring financial institution 710 may be configured to perform the processing of the transaction processing server 712 and the issuing financial institution 702. The transaction processor may include rules and data suitable for use in making a determination of approval or denial of the payment transaction based on the data included therein. For instance, the issuing financial institution 702 and/or transaction processing server 712 may set limits on transaction type, transaction amount, etc. that may be stored in the transaction processor and used to determine approval or denial of a payment transaction based thereon. In such instances, the acquiring financial institution 710 may receive an authorization response for the payment transaction even if the transaction processing server 712 is unavailable, ensuring that transactions are processed and no downtime is experienced even in instances where communication is unavailable. In such cases, the transaction processor may store transaction details for the payment transactions, which may be transmitted to the transaction processing server 712 (e.g., and from there to the associated issuing financial institutions 702) once communication is reestablished.

In some embodiments, transaction processors may be configured to include a plurality of different communication channels, which may utilize multiple communication cards and/or devices, to communicate with the transaction processing server 712 for the sending and receiving of transaction messages. For example, a transaction processor may be comprised of multiple computing devices, each having multiple communication ports that are connected to the transaction processing server 712. In such embodiments, the transaction processor may cycle through the communication channels when transmitting transaction messages to the transaction processing server 712, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 710 may identify that an authorization request involves an issuing financial institution 702 (e.g., via the bank identification number included in the transaction message) for which no value-added services are required. The transaction processor at the acquiring financial institution 710 may then transmit the authorization request directly to the transaction processor at the issuing financial institution 702 (e.g., without the authorization request passing through the transaction processing server 712), where the issuing financial institution 702 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 712 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 708, acquiring financial institution 710, etc.) for processing using this advanced network, and to quickly and efficiently receive a response regarding the ability for a consumer 704 to fund the payment transaction.

### Computer System Architecture

FIG. 8 illustrates a computer system 800 in which embodiments of the present disclosure, or portions thereof, may be implemented as computer-readable code. For example, the processing server 102 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement, for example, the methods of FIGS. 3 and 5-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3 and 5-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

The processor device 804 may comprise one or more modules or engines configured to perform the functions of the computer system 800. Each of the modules or engines may be implemented using hardware and, in some instances, may also utilize software, such as corresponding to program code and/or programs stored in the main memory 808 or secondary memory 810. In such instances, program code may be compiled by the processor device 804 (e.g., by a compiling module or engine) prior to execution by the hardware of the computer system 800. For example, the program code may be source code written in a programming language that is translated into a lower level language, such as assembly language or machine code, for execution by the processor device 804 and/or any additional hardware components of the computer system 800. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 800 to perform the functions disclosed herein. It will be apparent to persons having skill in the relevant art that such processes result in the computer system 800 being a specially configured computer system 800 uniquely programmed to perform the functions discussed above.

Techniques consistent with the present disclosure provide, among other features, systems and methods for consumer verification of a payment transaction that exceeds previously established account limitations. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for analyzing geographical pricing for products using transaction data, comprising:
storing, in a product database of a processing server, a plurality of product data entries, wherein each product data entry includes data related to a product including at least a product identifier and a plurality of price values, each price value being associated with a geographic area of a plurality of geographic areas;
receiving, by a receiving device of the processing server, a transaction message for a payment transaction via a payment network, wherein the transaction message is formatted based on one or more standards and includes a plurality of data elements including at least a first data element configured to store a geographic location and one or more additional data elements configured to store a specific product identifier and an associated price;
extracting, by a processing device of the processing server, the specific product identifier and the associated price stored in the one or more additional data elements included in the received transaction message;
executing, by the processing device of the processing server, a query on the product database to identify a specific product data entry where the included product identifier corresponds to the extracted specific product identifier; and
updating, by the processing device of the processing server, a specific price value of the plurality of price values included in the identified specific product data entry in the product database based on the extracted associated price, wherein the specific price value is associated with a geographic area that includes the geographic location stored in the first data element included in the received transaction message.

2. The method of claim 1, further comprising:
generating, by the processing device of the processing server, a price map, wherein the price map illustrates each of the plurality of geographic areas and indicates the associated price value including the updated specific price value for the specific product data entry.

3. The method of claim 1, further comprising:
receiving, by the receiving device of the processing server, an electronic signal comprising a data request, wherein the data request includes the specific product identifier.

4. The method of claim 3, further comprising:
electronically transmitting, by a transmitting device of the processing server, a response signal to the received electronic signal, wherein the response signal comprises one or more price values and associated geographic areas included in the specific product data entry.

5. The method of claim 3, further comprising:
generating, by the processing device of the processing server, a price map, wherein the price map illustrates each of the plurality of geographic areas and indicates the associated price value including the updated specific price value for the specific product data entry; and
electronically transmitting, by a transmitting device of the processing server, a response signal to the received electronic signal, wherein the response signal comprises the generated price map.

6. A system for analyzing geographical pricing for products using transaction data, comprising:
storing, in a product database of a processing server, a plurality of product data entries, wherein each product data entry includes data related to a product including at least a product identifier and a plurality of price values, each price value being associated with a geographic area of a plurality of geographic areas;
receiving, by a receiving device of the processing server, a transaction message for a payment transaction via a payment network, wherein the transaction message is formatted based on one or more standards and includes a plurality of data elements, including at least a first data element configured to store a geographic location, and addendum date, the addendum data configured to store at least a specific product identifier and associated an associated price;
extracting, by a processing device of the processing server, the specific product identifier and the associated price stored in the addendum data included in the received transaction message;
executing, by the processing device of the processing server, a query on the product database to identify a specific product data entry where the included product identifier corresponds to the extracted specific product identifier; and
updating, by the processing device of the processing server, a specific price value of the plurality of price values included in the identified specific product data entry in the product database based on the extracted associated price, wherein the specific price value is associated with a geographic area that includes the geographic location stored in the first data element included in the received transaction message.

7. The method of claim 6, further comprising:
generating, by the processing device of the processing server, a price map, wherein the price map illustrates each of the plurality of geographic areas and indicates the associated price value including the updated specific price value for the specific product data entry.

8. The method of claim 6, further comprising:
receiving, by the receiving device of the processing server, an electronic signal comprising a data request, wherein the data request includes the specific product identifier.

9. The method of claim 8, further comprising:
electronically transmitting, by a transmitting device of the processing server, a response signal to the received electronic signal, wherein the response signal comprises one or more price values and associated geographic areas included in the specific product data entry.

10. The method of claim 8, further comprising:
generating, by the processing device of the processing server, a price map, wherein the price map illustrates each of the plurality of geographic areas and indicates the associated price value including the updated specific price value for the specific product data entry; and
electronically transmitting, by a transmitting device of the processing server, a response signal to the received electronic signal, wherein the response signal comprises the generated price map.

11. A system for analyzing geographical pricing for products using transaction data, comprising:
a product database of a processing server configured to store a plurality of product data entries, wherein each product data entry includes data related to a product including at least a product identifier and a plurality of price values, each price value being associated with a geographic area of a plurality of geographic areas;
a receiving device of the processing server configured to receive a transaction message for a payment transaction via a payment network, wherein the transaction message is formatted based on one or more standards and includes a plurality of data elements including at least a first data element configured to store a geographic location and one or more additional data elements configured to store a specific product identifier and an associated price; and
a processing device of the processing server configured to
extract the specific product identifier and the associated price stored in the one or more additional data elements included in the received transaction message,
execute a query on the product database to identify a specific product data entry where the included product identifier corresponds to the extracted specific product identifier, and
update a specific price value of the plurality of price values included in the identified specific product data entry in the product database based on the extracted associated price, wherein the specific price value is associated with a geographic area that includes the geographic location stored in the first data element included in the received transaction message.

12. The system of claim 11, wherein the processing device of the processing server is further configured to generate a price map, wherein the price map illustrates each of the plurality of geographic areas and indicates the associated price value including the updated specific price value for the specific product data entry.

13. The system of claim 11, wherein the receiving device of the processing server is further configured to receive an electronic signal comprising a data request, wherein the data request includes the specific product identifier.

14. The system of claim 13, further comprising:
a transmitting device of the processing server configured to electronically transmit a response signal to the received electronic signal, wherein the response signal comprises one or more price values and associated geographic areas included in the specific product data entry.

15. The system of claim 13, further comprising:
a transmitting device of the processing server, wherein
the processing device of the processing server is further configured to generate a price map, wherein the price map illustrates each of the plurality of geographic areas and indicates the associated price value including the updated specific price value for the specific product data entry, and
the transmitting device of the processing server is configured to electronically transmit a response signal to the received electronic signal, wherein the response signal comprises the generated price map.

16. A system for analyzing geographical pricing for products using transaction data, comprising:
a product database of a processing server configured to store a plurality of product data entries, wherein each product data entry includes data related to a product including at least a product identifier and a plurality of price values, each price value being associated with a geographic area of a plurality of geographic areas;
a receiving device of the processing server configured to receive a transaction message for a payment transaction via a payment network, wherein the transaction message is formatted based on one or more standards and includes a plurality of data elements, including at least a first data element configured to store a geographic location, and addendum date, the addendum data configured to store at least a specific product identifier and associated an associated price;
a processing device of the processing server configured to
extract the specific product identifier and the associated price stored in the addendum data included in the received transaction message,
execute a query on the product database to identify a specific product data entry where the included product identifier corresponds to the extracted specific product identifier, and
update a specific price value of the plurality of price values included in the identified specific product data entry in the product database based on the extracted associated price, wherein the specific price value is associated with a geographic area that includes the geographic location stored in the first data element included in the received transaction message.

17. The system of claim 16, wherein the processing device of the processing server is further configured to generate a price map, wherein the price map illustrates each of the plurality of geographic areas and indicates the associated price value including the updated specific price value for the specific product data entry.

18. The system of claim 16, wherein the receiving device of the processing server is further configured to receive an electronic signal comprising a data request, wherein the data request includes the specific product identifier.

19. The system of claim 18, further comprising:
a transmitting device of the processing server configured to electronically transmit a response signal to the received electronic signal, wherein the response signal comprises one or more price values and associated geographic areas included in the specific product data entry.

20. The system of claim 18, further comprising:
a transmitting device of the processing server, wherein
the processing device of the processing server is further configured to generate a price map, wherein the price map illustrates each of the plurality of geographic areas and indicates the associated price value including the updated specific price value for the specific product data entry, and
the transmitting device of the processing server is configured to electronically transmit a response signal to the received electronic signal, wherein the response signal comprises the generated price map.
